(19) United States
(12) Patent Application Publication
(10) Pub. No.: US 2020/0319650 A1
(43) Pub. Date: Oct. 8, 2020

(54) Unmanned Rover for Implementing Precise and Repetitive Processes and Operations

(71) Applicants: Donald Lee Chalker, Jacksonville, FL (US); Eyal Wirsansky, Jacksonville, FL (US)

(72) Inventors: Donald Lee Chalker, Jacksonville, FL (US); Eyal Wirsansky, Jacksonville, FL (US)

(21) Appl. No.: 16/842,680

(22) Filed: Apr. 7, 2020

Related U.S. Application Data
(60) Provisional application No. 62/830,493, filed on Apr. 7, 2019.

(51) Int. Cl. G05D 1/02; B60P 3/22; G01S 19/42; B64C 39/02; G05D 1/00; G05D 1/12

(52) U.S. Cl. CPC G05D 1/0219; B60P 3/22; G01S 19/42; B64C 39/024; G05B 13/0265; G05D 1/0276; G05D 1/0027; G05D 1/12; G05D 1/0231

(57) ABSTRACT

The present disclosure provides for a rover used for painting and surveying. In some embodiments, a rover may comprise semi-autonomous small-scale vehicle with targeted capabilities to streamline processes that require precision or repetition. In some implementations, a rover may consistently and accurately traverse a space based on an instructed path and with a predefined purpose, such as painting, applying treatments, or seeding, as non-limiting examples. In some embodiments, the rover may paint lines in a defined space, like a parking lot or sports field. In some implementations, the rover may be deployable on a variety of surfaces, such as tile, mud, or grass. In some aspects, the rover may be configured to run according to Global Positioning System (GPS) coordinates or other coordinate system that may allow for automated patterns and paths. In some embodiments, the rover may run automated routes pre-programmed by a user.

### CROSS-REFERENCE TO RELATED APPLICATION

This application claims priority to and the full benefit of U.S. Provisional Patent Application Ser. No. 62/830,493, filed Apr. 7, 2019, and titled “UNMANNED ROVER FOR IMPLEMENTING PRECISE AND REPETITIVE PROCESSES AND OPERATIONS”, the entire contents of which are incorporated in this application by reference.

### BACKGROUND OF THE DISCLOSURE

For centuries, manual labor has been the primary method of maintaining grounds. Over the past century, technology has evolved to partner with manual labor to allow for more efficient maintenance, such as with the invention of ploughs, lawn mowers, and other machinery. Still, manual labor has remained integral to the process.

Remote controlled vehicles began as novelty toys for the masses or sophisticated technology too expensive for everyday uses. Remotely controllable vehicles may be nautical, aerial, or terrestrial-focused. Remotely controllable vehicles are usually operated by a human being. There are a variety of uses for a remotely controllable vehicle, such as for scientific research, law enforcement, or for recreation. A space exploration vehicle incorporates autonomous technology with remotely controllable features, but as these vehicles operate in extreme conditions and, must withstand high levels of acceleration, pressure, corrosion, dust, and being functional without a need for repair, the vehicles are cost prohibitive for more mundane uses.

A radio controlled (R/C) vehicle is a common version of a remote-controlled vehicle, and typically includes a battery, electric, or gas-powered vehicle that can be controlled from a distance using a specialized transmitter or remote. Traditionally, these vehicles were controlled by a radio-frequency link. Often, R/C vehicles had on-road and off-road models, with different suspension capabilities based on the designation. Some R/C vehicles have suspension models similar to full-scale cars. Still, these vehicles remained mostly a novelty.

The first successful autonomously controlled vehicle was developed in 1977 in Japan. Using two cameras, the vehicle was able to track white street markers and reached speeds up to 20 miles per hour (mph). Over time, autonomous controlled vehicles integrated obstacle avoidance and off-road driving in both nighttime and day conditions. This is an area of continuing innovation, with companies attempting to successfully test driverless cars completely without safety drivers.

### SUMMARY OF THE DISCLOSURE

Despite these broad innovations, there is still a need for a semi-autonomous small-scale vehicle with targeted capabilities to streamline processes that require precision or repetition. According to the present disclosure, a rover may consistently and accurately traverse a space based on an instructed path and with a predefined purpose, such as painting, applying treatments, or seeding, as non-limiting examples. In some embodiments, the rover may paint lines in a defined space, like a parking lot or sports field. In some implementations, the rover may be deployable on a variety of surfaces, such as tile, mud, or grass. In some aspects, the rover may be configured to run according to Global Positioning System (GPS) coordinates or other coordinate system that may allow for automated patterns and paths. In some embodiments, the rover may run automated routes pre-programmed by a user.

In some implementations, the rover may improve performance of the task over time, such as through processing of collected data. In some aspects, the rover may signal or report if a condition needs to be inspected or maintained. In some embodiments, the rover may transmit signals based on predefined condition thresholds, such as low paint levels, low power levels, or the presence of an impeding object. In some implementations, the rover may be useful to paint or repaint surfaces, such as sports fields, pools, or parking lots. In some aspects, rovers may be able to identify premade patterns or conditions, which may allow for enhancement of the area.

The present disclosure relates to a rover for performing repetitive processes. In some aspects, the rover may comprise at least one repetitive process mechanism, wherein the rover may be configured to perform a first repetitive process, one or more communication mechanisms configured to communicate with an external device; a supply reservoir configured to contain the material; a mobility mechanism configured to move the rover, wherein the mobility mechanism is based at least in part on the first repetitive process; a control mechanism configured to automate performance of the first repetitive process based on instructions through control of one or more of the at least one repetitive process mechanism, the mobility mechanism, and the supply reservoir, wherein the control mechanism receives instructions through at least a portion of the one or more communication mechanisms; and one or more memory resources configured to store instructions. In some embodiments, the first repetitive process may comprise dispensing a material according to instructions for the first repetitive process.

Implementations may comprise one or more of the following features. In some aspects, at least one communication mechanism may be wireless. In some embodiments, the rover may communicate with an aerial drone configured to provide guidance for the first repetitive process based on visual data. In some implementations, the rover may communicate with an external device, wherein the external device may provide a reference for position data.

In some aspects, the repetitive process may comprise painting. In some embodiments, the repetitive process may comprise treating a body of water. In some implementations, the mobility mechanism may provide drone mobility on a solid surface. In some aspects, the mobility mechanism may provide drone mobility on a fluid or semi-solid surface. In some aspects, the mobility mechanism may allow for navigation on or under fluid or semi-solid surface. Implementations of the described techniques may comprise hardware, a method or process, or computer software on a computer-accessible medium. In some aspects, corresponding computer systems, apparatus, and computer programs recorded on one or more computer storage devices, may be configured to perform the actions of the methods.

The present disclosure relates to a system for repetitive processes may comprise a plurality of rovers. In some aspects, each rover may comprise: at least one repetitive process mechanism, wherein the rover is configured to perform a first repetitive process, wherein the first repetitive process may comprise dispensing a material according to instructions for the first repetitive process; one or more communication mechanisms configured to communicate with an external device; a supply reservoir configured to contain the material; a mobility mechanism configured to move the rover, wherein the mobility mechanism is based at least in part on the first repetitive process; a control mechanism configured to automate performance of the first repetitive process based on instructions through control of one or more of the at least one repetitive process mechanism, the mobility mechanism, and the supply reservoir, wherein the control mechanism receives instructions through at least a portion of the one or more communication mechanisms; and one or more memory resources configured to store instructions, wherein the plurality of rovers are configured to perform the first repetitive process collectively.

Implementations may comprise one or more of the following features. In some embodiments, at least one communication mechanism may be wireless. In some implementations, at least a portion of the plurality of rovers may communicate with an external device, wherein the external device may provide a reference for position data. In some aspects, at least one of the plurality of rovers may provide a reference for position data for at least a portion of the plurality of rovers. In some embodiments, the rover may communicate with an aerial drone configured to provide guidance for the first repetitive process based on visual data.

In some implementations, the repetitive process may comprise painting. In some aspects, the mobility mechanism may provide drone mobility on solid surface. In some embodiments, the mobility mechanism may provide drone mobility on a fluid or semi-solid surface. In some aspects, at least a portion of the plurality of rovers may comprise a proximity sensor configured to monitor proximity of other rovers within the system. In some aspects, a mobility mechanism may provide drone mobility on or under surfaces. For example, a drone may be able to navigate underwater, such as above the bottom surface or on the bottom surface of the body of water. As another example, where the surface may comprise a semi-solid, a drone may navigate partially submerged.

In some embodiments, the system may comprise an aerial drone, wherein the aerial drone may wirelessly communicate with at least one of the plurality of rovers, and wherein the aerial drone may provide rover guidance based on visual data. In some implementations, the repetitive process may comprise treating a body of water. In some aspects, at least one repetitive process mechanism may disperse chemicals into the body of water. Implementations of the described techniques may comprise hardware, a method or process, or computer software on a computer-accessible medium.

A system of one or more computers may be configured to perform particular operations or actions by virtue of having software, firmware, hardware, or a combination of them installed on the system that in operation may cause the system to perform the actions. One or more computer programs may be configured to perform particular operations or actions by virtue of including instructions that, when executed by data processing apparatus, may cause the apparatus to perform the actions. In some aspects, corresponding computer systems, apparatus, and computer programs recorded on one or more computer storage devices, may be configured to perform the actions of the methods.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary rover, wherein the rover is painting a surface of a pool, according to some embodiments of the present invention.

FIG. 2 illustrates a cross-section view of an exemplary rover, according to some embodiments of the present invention.

FIG. 3 illustrates a top-down view of an exemplary rover, according to some embodiments of the present invention.

FIG. 4 illustrates an exemplary rover painting the surface of a parking lot, according to some embodiments of the present invention.

FIG. 5 illustrates an exemplary rover repainting the surface of a parking lot, according to some embodiments of the present invention.

FIG. 6 illustrates an exemplary rover painting a football field, according to some embodiments of the present invention.

FIG. 7 illustrates exemplary rovers treating and assessing a body of water, according to some embodiments of the present invention.

FIG. 8 illustrates a block diagram of an exemplary embodiment of a rover, according to some embodiments of the present invention.

FIG. 9 illustrates an exemplary processing and interface system, according to some embodiments of the present invention.

### DETAILED DESCRIPTION

The present disclosure provides generally for a rover used for painting and surveying. According to the present disclosure the rover may have the capability of painting or repainting surfaces using GPS. The rover may have the capability to sense where previous lines were on roadways, parking lots, etc., in order to repaint them, as well as sense when objects may interfere with the device as well.

The rover may also be used to spread chemicals to treat large agricultural areas, or sporting fields in an efficient time while unmanned. The device may also be programmed to spray or design a certain pattern based on the users request or the specifications needed for the task being completed. Along with these capabilities the device may also paint surfaces while being submerged under water; also allowing for the paint to adhere to the surface as well without the drainage of any body of water the rover is in. This may include pools, lakes, oceans but is not limited to such.

In the following sections, detailed descriptions of examples and methods of the disclosure will be given. The description of both preferred and alternative examples though thorough are exemplary only, and it is understood that to those skilled in the art variations, modifications, and alterations may be apparent. It is therefore to be understood that the examples do not limit the broadness of the aspects of the underlying disclosure as defined by the claims.

### Glossary

Rover: as used herein refers to an unmanned land or water vehicle.
Paint: as used herein refers to any material, solution, or compound that may be applied to a surface. In some aspects, paint may comprise paints or coatings. In some embodiments, paint may comprise a treatment, such as for pesticides or fertilizer.
Drone: as used herein refers to an unmanned aerial vehicle.
Repetitive Process Mechanism: as used herein refers to a process that may require a repetition of actions to accomplish a task or project. Throughout the application, repetitive process mechanisms may be described in reference to the particular repetitive process for each figure. For example, where the repetitive process may comprise painting lines in a parking lot, the repetitive process mechanism may be described as paint mechanism.
Supply Reservoir: as used herein refers to a portion of a rover that may contain a supply of material or substance that a rover may disperse in its performance of the repetitive process. Throughout the application, supply reservoir may be described in reference to the particular repetitive process for each figure. For example, where the repetitive process may comprise painting, the supply reservoir may be described as a paint reservoir.

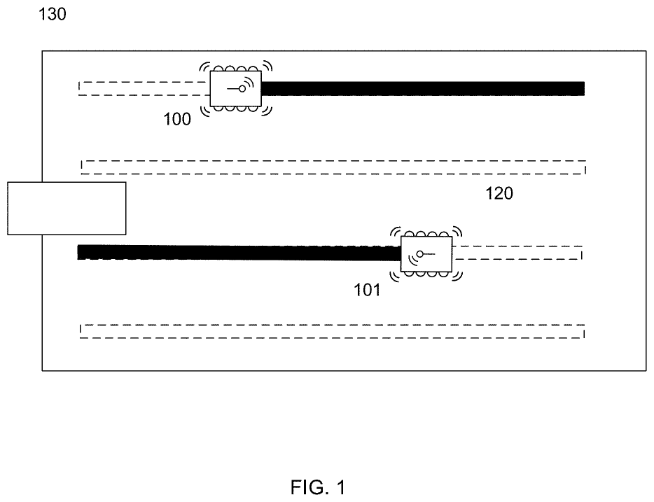

Referring now to FIG. 1, an exemplary rover 100 is illustrated, wherein the rover 100 is painting a surface of a pool 130. In some aspects, a rover 100 may comprise components that allow for precise painting of a surface. In some embodiments, a paint pattern 120 and the specifications of the pool 130 may be preprogrammed into the rover 100, which may allow the rover 100 to navigate the surface and paint according to the specifications. In some implementations, the rover 100 may receive a relative paint pattern 120, wherein the rover 100 may determine its position within the pool 130 based on relative proximity. For example, the rover 100 may detect its distance from each wall to determine its position within the pool 130.

In some aspects, the rover 100 may be placed at a known beginning point with the paint pattern 120 instructions based around that original location. In some implementations, the rover 100 may paint when the pool 130 has been drained and the surface is dry. In some embodiments, the rover 100 may paint when the pool 130 holds water. In some implementations, the rover 100 may comprise an air power source that may be able to temporarily create a dry spot so the rover 100 may apply paint. In some aspects, the rover 100 may continue to dry the area until the paint is sufficiently dry. In some implementations, the rover 100 may comprise a quick dry mechanism, such as a quick-dry coating, ultraviolet treatment, or high heat.

In some embodiments, the rover 100 may comprise sensors that may be able to detect the presence of an impediment on their path. In some implementations, the rover 100 may be able to move or navigate around the impediment. In some aspects, the rover 100 may relay the information to a user or external device, which may resolve the issue. For example, a small rock may be located on the paint path, and the rover 100 may be able to blow or brush it out of the way. As another example, a large branch may be located on the paint path, and a person may need to manually retrieve or move it. Sensing objects may be particularly useful where the pool 130 may be outdoors or a natural pool, such as a manmade pond or lake.

In some implementations, the rover 100 may be remotely controlled, such as by a nearby user with a remote control or remotely through a wireless network. In some aspects, the control may comprise a screen with video capabilities linking to an onboard camera of the rover 100. In some embodiments, the rover 100 may generally operate automatically with override capabilities, such as in the event of an emergency. In some implementations, the rover 100 may be programmed based on a received set of instructions, and the rover 100 may comprise memory resources for storing the instructions. In some embodiments, memory resources may allow the rover 100 to store execution data, such as where the paint was actually dispersed, time data, location data, collected visual data, material data, or position data, as non-limiting examples.

In some aspects, multiple rovers 100, 101 may be treating a surface simultaneously, which may allow for a faster treatment. In some embodiments, multiple rovers 100, 101 may comprise proximity sensors to ensure the rovers 100, 101 avoid each other on their paths. In some implementations, a user may provide a desired path and a number of rovers 100, 101 reserved for the task, and orchestrated paths may be generated, such as through software, programming, or artificial intelligence as non-limiting examples.

In some implementations, multiple rovers 100, 101 may be used at one time to cover a surface. In some implementations, at least one of the rovers 100 may comprise a proximity sensor that may determine the distance between the rovers 100, 101. In some implementations, the proximity sensor may ensure rovers 100, 101 do not collide with one another as well as preventing singular rovers 100 from crashing into objects in their area. For example, the proximity sensor may trigger an auto stop or shut down when it senses a rover may crash into something. In some aspects, the rover 100, 101 may have a set distance in which the sensor triggers the rover 100, 101 to stop. For example, the sensor may automatically shut down the rover 100 when within a six-inch radius of an object or another rover 101.

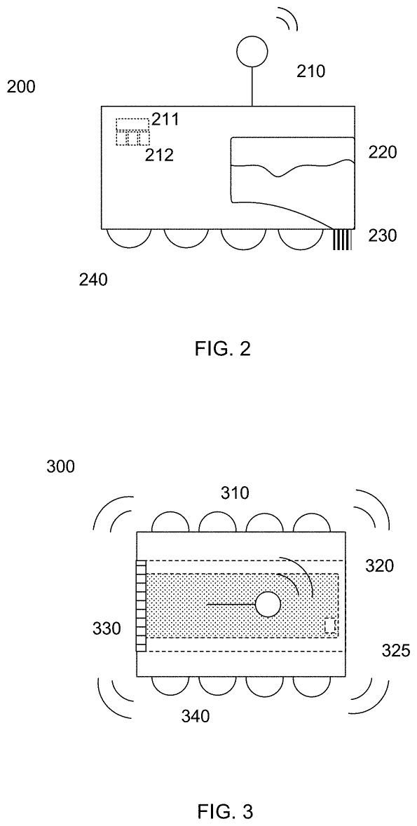

Referring now to FIG. 2, a cross-section view of an exemplary rover 200 is illustrated. In some aspects, the rover 200 may comprise a communication mechanism 210. In some implementations, the rover 200 may comprise a paint mechanism 230 with a paint reservoir 220. In some embodiments, the rover 200 may comprise a mobility mechanism 240, such as wheels, tracks, or hover. In some implementations, the mobility mechanism 240 may comprise wheels that allow for 360° movement without requiring reversal or turning.

In some aspects, the paint mechanism 230 may be located on a movable boom. A movable boom may allow the paint mechanism 230 to pivot according to the paint specifications without requiring the rover 200 to turn a specific direction to properly align with the paint path. In some embodiments, a movable boom may rotate, extend, retract, lower, or combinations thereof, as non-limiting examples. In some implementations, the paint mechanism 230 may be adjustable. For example, the paint mechanism 230 may be able to pivot, which may allow for changes in line thickness or design.

In some aspects, a rover 200 may depend on GPS to determine its path, wherein GPS coordinates may define its path. In some embodiments, a rover 200 may use GPS for a portion of the path, such as to confirm the origin of the path and intermittently as a secondary verification that the rover 200 is on the correct path, as defined. In some implementations, GPS may provide the controller with path data. For example, the rover 200 may be tasked with painting a baseball field using a hub to provide relative position guidance, and GPS coordinates may be collected as additional information, such as that may be used by future rovers without the use of the hub.

In some aspects, the rover 200 may be controlled by an external device with an administrative application. In some embodiments, the external device may comprise a general network device with an application installed, such as a smartphone, tablet, laptop, or other computing device. In some implementations, the external device may comprise a device specifically designed to interact with the rover 200, such as a rover-specific remote control or a programmed portable device configured to coordinate painting of an area, as non-limiting examples.

In some embodiments, the communication mechanism 210 may be used to communicate with a wireless device used to control the rover 200, wherein the wireless device may transmit instructions to a control mechanism 211. In some aspects, a rover 200 may comprise memory resources 212 that may store one or more instruction data, repetitive process execution data, position data, material data, sensor data, component status, or other collected data, as non-limiting examples. In some embodiments, the communication mechanism 210 may connect the rover 200 to an external server or to the internet. In some aspects, the communication device 210 may connect the rover 200 to an aerial drone used to aid the rover 200 in surveying larger areas such as parking lots, sporting fields, bodies of water, and other non-limiting examples.

In some aspects, the communication device 210 may be used to relay visual data or position data from the aerial drone to the rover 200. In some aspects, the communication mechanism 210 may communicate within a fixed area. For example, the communication mechanism 210 may relay information from the aerial drone from 300 meters above the rover's 200 initial position on the ground. In some embodiments, the distance may be limited by the communication mechanism 210 type, such as wireless connection to a mobile network, a Bluetooth connection, and local IR communication.

Referring now to FIG. 3, a top-down view of an exemplary rover 300 is illustrated. In some embodiments, the rover 300 may comprise a communication mechanism 210. In some aspects, the rover 300 may comprise a paint reservoir 320 with refill port 325 and paint mechanism 330. In some implementations, the rover 300 may comprise a hollow portion or recess behind the paint mechanism 330, which may allow the rover 300 to travel along a path without affecting the painted surface.

In some embodiments, the rover 300 may use built in sensors to be able to tell where objects near, or in its way are, rather than relying on the GPS system 310. The rover 300 may have different attachable dispensers for the disbursement of whatever liquid or chemical may be in the various attachment. The rover 300 may also have a permanent canister or some sort of compartment that may allow for a predefined volume of paint, chemicals, or other material, to be stored in the device at one time.

In some aspects, the rover 300 may comprise a mobility mechanism 340 that may allow the rover 300 to traverse over surfaces, such as solid, semi-solid, or liquid surfaces. In some embodiments the rover 300 may roll on wheels for closer encounter tasks such as: parking lots, roadway painting, but it may also use rotors to hover above the surface so that it may encounter a larger surface at one time such as: crop fields or sporting fields. In some aspects, mobility mechanism 340 may be able to transform into wheels and vice-versa. In some embodiments, a rover 300 may comprise multiple repetitive process mechanisms, which may allow for compatibility when dealing with different tasks. In some implementations, the rover 300 may be automated from a possible remote control or it may be done manually before the task has started by the user.

In some embodiments, the rover 300 may communicate with a wireless device. In some embodiments, the device may be a smart device or a unique device which specifically controls the rover 300. For example, the smart device may have an application that may be downloaded onto the device and sync with the rover 300 to allow for wireless communication. As another example, the preprogrammed device may be integrated with the rover 300 and may control the device wirelessly.

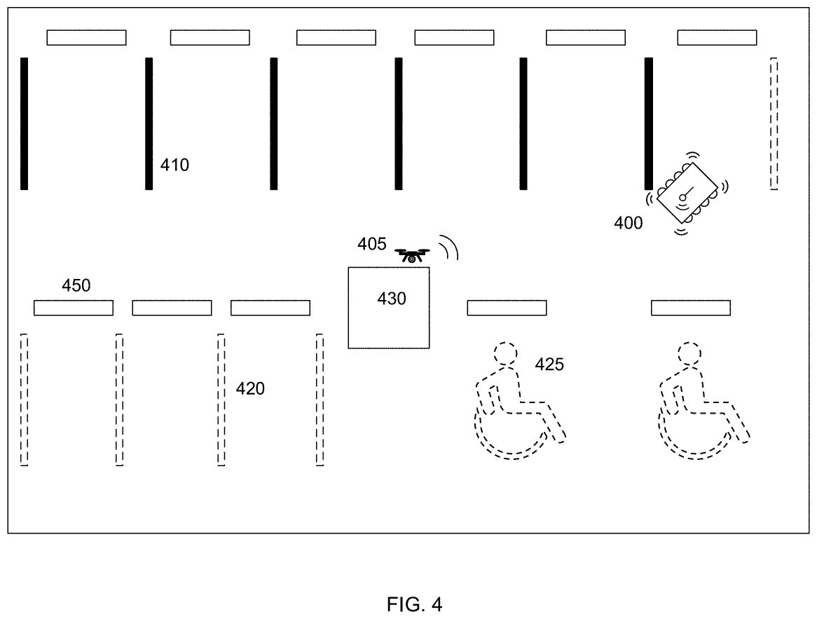

Referring now to FIG. 4, an exemplary rover 400 painting the surface of a parking lot is illustrated. In some aspects, the rover 400 may paint the surface based on a predefined pattern 410, 420, 425, such as a ten-foot line, six inches wide, every eight feet for two hundred feet. In some embodiments, the rover 400 may paint the surface based on relative locations, such as a ten-foot line, six inches wide perpendicular to each parking block.

In some aspects, the rover 400 may be able to distinguish between surfaces, such as asphalt, grass, concrete, soil, and water, as non-limiting examples. The rover 400 may apply the paint to a predefined surface type. In some embodiments, the rover 400 may switch paint or treatments while traversing a path based on the surface type. For example, the rover 400 may be seeding a field on portions with dirt and applying a weed treatment on old grass areas. As another example, the rover 400 may be painting grass areas and concrete areas, but only sealing portions on the concrete areas. As another example, the rover 400 may be sealing asphalt and then painting lines over a portion of the sealed asphalt. The rover 400 may apply sealant over the asphalt and may distinguish between bare asphalt and sealed asphalt before applying the paint.

In some implementations, the rover 400 may pair with a drone 405, wherein the drone 405 may communicate location data, paint pattern data, or other information that may assist the rover 400 in painting the surface. In some embodiments, one or both the rover 400 and the drone 405 may depend on a central known location 430, which may be predefined to establish a baseline coordinate.

In some aspects, the rover 400 may comprise a collision prevention mechanism, which may allow for avoidance of objects 450 near the path. In some implementations, multiple rovers 400 may be deployed on the parking lot to cover more area in less time, which may also require less recharging and refilling. In some embodiments, each rover 400 may be programmed with a unique path, which may coordinate the paths of multiple rovers 400. Coordinated paths may allow for increased efficiency and limit accidents between rovers. A collision prevention mechanism may limit collision between rovers 400.

In some embodiments, the drone 405 may be able to refill the rover 400, such as when a threshold minimum reservoir level is detected. In some aspects, a user may need to manually refill the rover 400. In some implementations, the rover 400 may periodically return to a refill station. In some implementations, the rover 400 may be controlled by an aerial drone that may communicate coordinates from the air to the ground. In some implementations, the aerial drone may relay all relevant information that may be programmed into the system to the rover 400 for proper delivery. For example, the aerial drone may hover over a parking lot, having a view of the entire parking lot from above, and then relay the predetermined markings to the rover 400 for the most accurate results.

In some implementations, the drone may use visual data to communicate to the rover 400 where different imperfections are in the area that is being used by the rover. In some implementations, the visual data may help with guidance through the repetitive process being used by the rover 400. For example, an aerial drone may identify a crack in asphalt or a light fixture that the rover 400 may need to accommodate for. An aerial drone may identify anomalies in the layout that may require external intervention. For example, instructions for the repetitive process may assume that the space is completely cleared, and an aerial drone may identify inconsistencies in the area, such as other equipment, debris, personnel, or other rovers 400, as non-limiting examples.

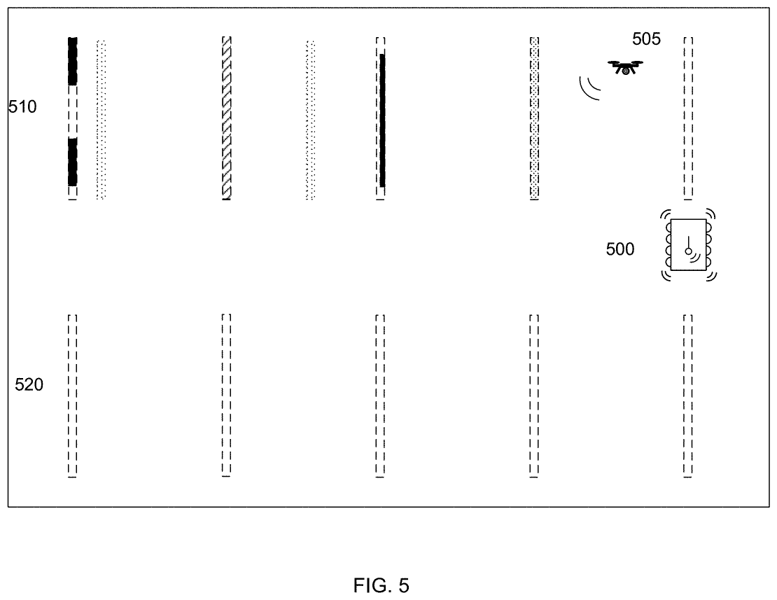

Referring now to FIG. 5, an exemplary rover 500 repainting the surface of a parking lot is illustrated. In some aspects, the rover 500 may be repainting markings on a parking lot. Parking lots often contain multiple markings with variable deterioration and fading. The rover 500 may be able to detect a range of characteristics of the prior markings 510, 520, such as levels of marking fidelity, the most recent application, and color. In some aspects, a drone 505 may be able to detect and confirm at least a portion of the characteristics, which may allow for more accurate surface mapping.

In some parking lots, old lines 510, 520 may be worn out and disfigured over time; causing confusion of where the parking boundaries are. In some aspects, the rover 500 may be able to remove the old lines, such as through scraping, chemical treatment, or water pressure, as non-limiting examples. In some aspects, the rover 500 may be repainting a parking lot with a completely different configuration, and removal of the old paint may occur in a separate step. In some implementations, the rover 500 may be refreshing the already existing format, and the rover 500 may remove paint as it goes.

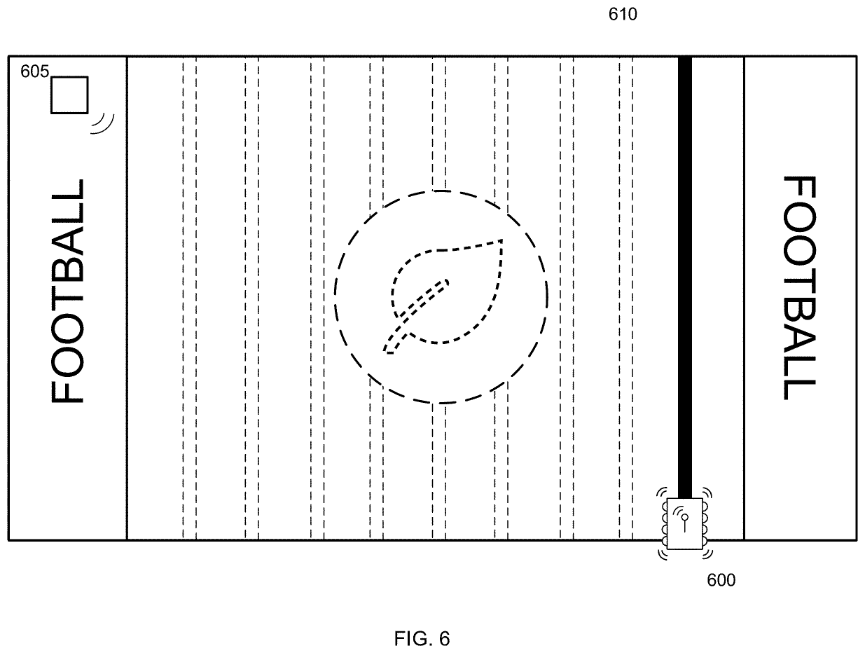

Referring now to FIG. 6, an exemplary rover 600 painting a football field 610 is illustrated. In some embodiments, the rover 600 may pair with a static device 605 that may establish a baseline coordinate for the football field 610. For example, the static device 605 may be placed in a corner of the football field 610 in a location that would not impede the painting of the surface. In some aspects, the static device 605 may be a base for the rover 600, such as a paint refill station, recharge station, or path instruction source.

In some embodiments, the rover 600 may comprise a communication mechanism that may communicate with an external device, such as through a wireless network, infrared, Bluetooth®, or nearfield communications, as non-limiting examples. Continuous communication through a wireless network may be processing heavy and drain the power source of the rover 600. The rover 600 may intermittently communicate through a wireless network, such as for path instructions by section of the field 610. In some aspects, the static device 605 may be plugged in to a power source or maintain its own separate power source, which may allow the communication and power requirements associated with communication to primarily shift from the rover 600 to the static device 605. In some embodiments, the rover 600 may periodically return to the static device 605, which may allow for low power nearfield communication or even hardwired connection between the two.

In some aspects, the path instructions may include, but not limited to, the speed, the width of the spray, color of the paint being used, the traversing method, the type of paint used, and the coordinates, as non-limiting examples. In some embodiments, the traversing method may include, wheels, hovering, submerge, or on a water surface, as non-limiting examples.

In some embodiments, the rover 600 may also treat the field 610 separately before or after the field has been painted as well as before or after the sporting event. The rover 600 may have the capability of simultaneously treating the field 610 with chemicals and painting it without mixing the two together. In some aspects, the rover 600 may have the capability of mixing paints or using multiple different paints/chemicals at once. For example, the rover 600 may separately carry three primary colors that may be mixed to create multiple colors necessary for the path. This may allow for a more effective use of space on the rover 600 than requiring a separate reservoir for each color or type.

In some aspects, the rover 600 may repeat a process to where the device follows similar instructions for each step of the process. In some aspects, the rover 600 may dispense material throughout the repetitive process followed by the device. For example, the material may comprise a paint, a coating, a pesticide, a cleaner, or a fertilizer, as non-limiting examples. In some aspects, the rover 600 may communicate with an external device to follow the repetitive process. In some aspects, the rover 600 may only dispense the material if the instructions inform the rover 600 to do so. For example, the instructions may identify where the rover 600 dispenses paint and in what pattern, and the rover 600 may then dispense the amount and type of material based on those instructions provide.

In some aspects, the rover 600 may be equipped with a supply reservoir to hold the material inside the rover 600 so that the material may be safely carried and dispensed while the rover 600 is mobile. For example, the supply reservoir may activate when programmed or triggered by the rover 600 to dispense the material at appropriate times. In some aspects, the material may have a pre-programmed dispensing method that may determine how the rover 600 dispenses the material at pre-determined times programmed by the user. In some implementation, the supply reservoir may be equipped with a painting mechanism to paint large areas with the material. For example, the painting mechanism may be used to paint large areas like sports fields, parking lots, or any other non-limiting examples.

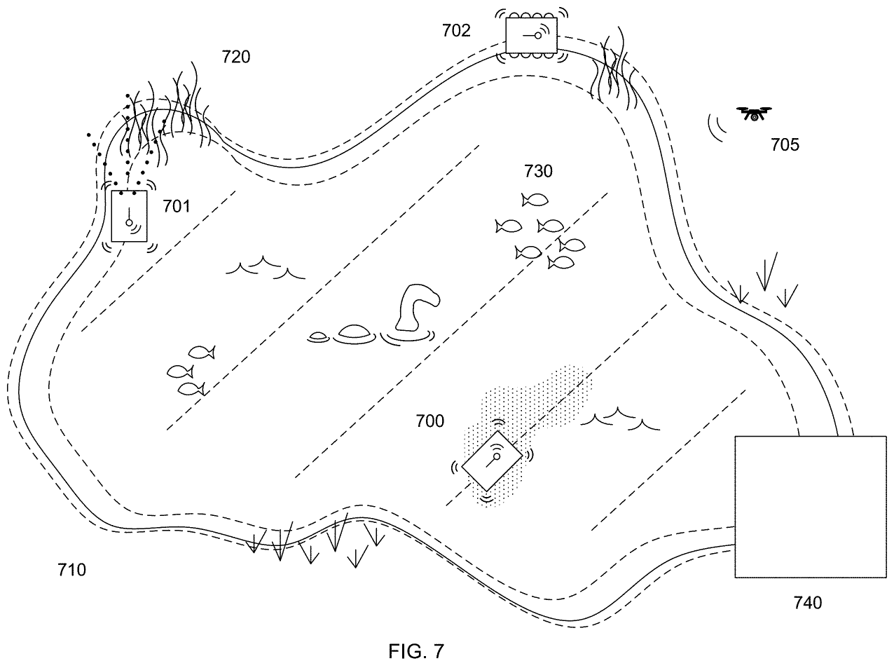

Referring now to FIG. 7, exemplary rovers 700, 701, 702 are illustrated treating and assessing a body of water 710. In some aspects, a water rover 700 may navigate the body of water 710, such as through preset channel paths, wherein a mobility mechanism may allow the rover 700 to traverse over a fluid In some embodiments, a shore rover 702 may travel along the edge of the body of water 710, wherein a mobility mechanism may allow the shore rover 702 to traverse over a solid or semi-solid surface, such as mud. In some implementations, a shallow-water rover 701 may travel in the shallow water perimeter of the body of water, which may include a fluid or semi-solid surface. In some aspects, the rovers 700, 701, 702 may apply treatments to their areas, such as pesticides, fertilizers, nourishment, and water treatments, as non-limiting examples. In some implementations, multiple rovers 700, 701, 702 may be deployed over a large surface. For example, multiple water rovers 700 may traverse the body water 710 along different paths, wherein the paths limit the chance of collision between rovers 700.

In some embodiments, the rovers 700, 701, 702 may assess flora 720 and fauna 730 of the body of water 710. For example, the water rover 700 may count the number of fish 730 in the body of water 710, which may be confirmed or countered by a secondary assessment from a drone 705. The drone 705 may provide a different perspective, such as an aerial view. As another example, the water rover 700 may periodically sample the water for water quality and microorganisms, as non-limiting examples. In some implementations, a water rover 700 may release dye into the body of water 710 to maintain the aesthetics.

In some embodiments, the rover 700, 701, 702 may be able to distinguish between flora and fauna types, such as between species, ages, or native versus invasive. A sophisticated level of recognition may allow for a better understanding and treatment of the body of water 710 and its surrounding area. For example, the body of water 710 may be a retention pond that helps improve water quality of an adjacent river and manages stormwater runoff. Extreme levels of fauna, flora, pH, chemicals, or temperature may affect the effectiveness of the retention pond. The water rover 700 may determine that there are too few fish in the body of water 710, which may prompt restocking fish.

In some aspects, the water rover 700 may submerge under water. In some embodiments, the rovers 700, 701, 702 may be able to navigate their paths and avoid impeding objects. In some implementations, the water rover 700 may be able to paint surfaces under water without the paint coming off and without draining any of the body of water 710. In some embodiments, the water rover 700 may be able to adhere the paint to the surface immediately after application to the surface. In some aspects, the water rover 700 may be able to lay down material that may dissolve over time creating a bond to the surface.

In some implementations, a water rover 700 may comprise sensors to avoid objects in the water 710, such as fish, rocks, alligators, snakes, debris, algae, plants, and others, and continue its treatment path. In some embodiments, the rovers 700, 701, 702 may use GPS to manage and track their paths. In some aspects, the rovers 700, 701, 702 may pair with a drone to provide path guidance. The rovers 700, 701, 702 may be preprogrammed to follow a path, may be manually controlled, or combinations thereof. For example, the rovers 700, 701, 702 may follow a predetermined path, and a user may alter their paths to adjust to new conditions or needs.

In other embodiments the water rover 700 may be used to coat the bottom of a pool or hot tub without draining that body of water 710. There may be some unique variation attachment to the water rover 700 that allows to coat and adhere the bottom of the body of water at the same time. The water rover 700 may also be used to treat bodies of water 710 with harmless chemicals that do not affect the objects in the water 710; these harmless chemicals may be used to kill algae, bacteria, or other unwanted issues in the bodies of water 710. In some implementations, the water rover 700 may obtain depth detection data, which may be used to calculate amounts of disbursed chemicals. In some aspects, the depth detection may occur in real time, which may allow for precise release of chemicals. In some embodiments, the depth detection data may be used to adjust future treatments.

In some aspects, the rovers 700, 701, 702 may be able to obtain information about the body of water 710, flora, and fauna to relate that back to a user or entity. In some embodiments, the rovers 700, 701, 702 may collect data about their performance and health, which may be useful for maintenance and optimization, wherein the rovers 700, 701, 702 may comprise memory resources that may allow for storage of one or both collected data and instruction data. In some implementations, the rovers 700, 701, 702 may self-optimize, such as through machine learning and artificial intelligence. In some embodiments, the data may be used and applied for manual or computed adjustment of behavior.

In some embodiments, the rovers 700, 701, 702 may be stored in a boathouse 740. In some aspects, a boathouse 740 may comprise a charging station, which may electrically charge the rovers 700, 701, 702. In some implementations, the boathouse 740 may provide refilling stations for substances dispersed by the rovers 700, 701, 702. The boathouse 740 may comprise a communication center that may allow for the exchange of instructions and data. For example, the rovers 700, 701, 702 may upload data collected from the body of water 710. As another example, the communication center may provide instructions, such as related to the path, data collection, or substance disbursement.

In some embodiments, instruction may provide base guidance for the repetitive process, wherein the base guidance may be supplemented. In some implementations, the additional guidance may be acquired from an external device, such as an aerial drone or other rovers 700, 701, 702, internal machine learning, internal computer vision, or internal sensors (such as GPS sensors, proximity sensors, or surface sensors), as non-limiting examples. In some aspects, instruction may provide exact guidance, such as path details, dispensing details, and location details, as non-limiting examples. In some implementations, instruction may be provided in real time, such as through a communication mechanism that receives wireless instruction from a remote control or other external device.

As an illustrative example, a system of rovers 700, 701, 702 may receive instruction to treat a body of water 710, wherein the instruction assigns each rover 700, 701, 702 a particular repetitive process. The boundaries of the body of water 710 may be precisely known, so the shore rover 702 may receive exact path and repetitive process instructions. The shallow water rover 701 may receive exact boundary information along with instruction to treat the shallow water of the body of water 710 limiting “shallow” to two feet deep. The shallow water rover 701 may comprise a depth sensor that identifies the depth of the water. The shallow water rover 701 may refine their instructions over time, such as through machine learning. The instructions for the water rover 700 may provide the exact boundaries of the body of water 710, and the water rover 700 may receive depth data from the shallow water rover 701. This may allow for a dynamic treatment of the body of water 710.

Where both the water rover 700 and the shallow water rover 701 perform a similar repetitive process, such as dispensing chemicals to reach predefined water quality levels, one or both may periodically or continuously measure the predefined water quality levels. The rovers 700, 701 may coordinate the treatment of the body of water 710, such as to prevent over or under treatment of areas that may easily overlap between shallow and deep regions. Over time, the coordination may become increasingly efficient.

In some aspects, the rover 700 may be used to survey large bodies of water. In some implementations. the rover 700 may hover above the water to survey the water from above collecting data above ground. In some aspects, the rover 700 may go below the surface of the water to survey the body of water. In some aspects, an aerial drone may be use visual data to guide the rover 700 under the body of water to prevent damages to the rover or surrounding animal life. In some aspects, the rover 700 may be used to treat the surrounding body of water which may include, but is not limited to, lakes, pools, rivers, creeks, retention ponds, etc.

In some aspects, different chemical solutions may be used to treat different bodies of water. For example, a chlorine solution may be used to treat a pool, whereas, a different solution may be used for a public body of water like a lake. In some aspects, the chemical solution may be based on user discretion if for personal use, or mandated, such as where a chemical solution may be provided if the rover is treating a public body of water.

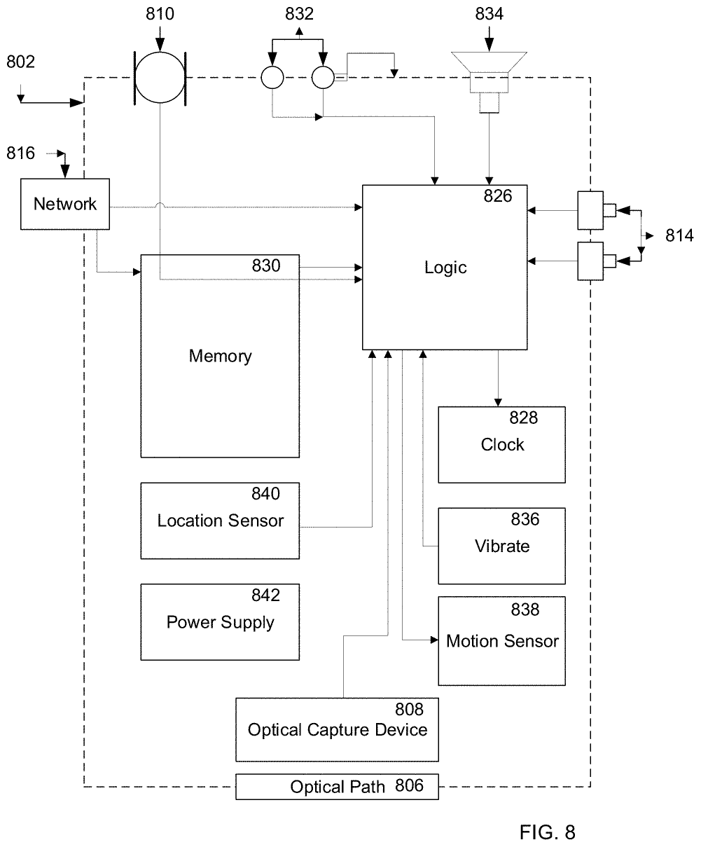

Referring now to FIG. 8, an exemplary block diagram of components for an exemplary rover 802 is illustrated. In some aspects, a rover 802 may comprise a controller of a drone or rover. The rover 802 may comprise an optical capture device 808, which may capture an image and convert it to machine-compatible data, and an optical path 806, typically a lens, an aperture, or an image conduit to convey the image from the rendered document to the optical capture device 808. The optical capture device 808 may incorporate a Charge-Coupled Device (CCD), a Complementary Metal Oxide Semiconductor (CMOS) imaging device, or an optical sensor of another type.

In some embodiments, the rover 802 may comprise a microphone 810, wherein the microphone 810 and associated circuitry may convert the sound of the environment, including spoken words, into machine-compatible signals. Input facilities 814 may exist in the form of buttons, scroll-wheels, or other tactile sensors such as touch-pads. In some embodiments, input facilities 814 may include a touchscreen display. Visual feedback 832 to the user may occur through a visual display, touchscreen display, or indicator lights. Audible feedback 834 may be transmitted through a loudspeaker or other audio transducer. Tactile feedback may be provided through a vibration module 836.

In some aspects, the rover 802 may comprise a motion sensor 838, wherein the motion sensor 838 and associated circuitry may convert the motion of the rover 802 into machine-compatible signals. For example, the motion sensor 838 may comprise an accelerometer, which may be used to sense measurable physical acceleration, orientation, vibration, and other movements. In some embodiments, the motion sensor 838 may comprise a gyroscope or other device to sense different motions.

In some implementations, the rover 802 may comprise a location sensor 840, wherein the location sensor 840 and associated circuitry may be used to determine the location of the device. The location sensor 840 may detect Global Position System (GPS) radio signals from satellites or may also use assisted GPS where the rover may use a cellular network to decrease the time necessary to determine location. In some embodiments, the location sensor 840 may use radio waves to determine the distance from known radio sources such as cellular towers to determine the location of the rover 802. In some embodiments these radio signals may be used in addition to and/or in conjunction with GPS.

In some aspects, the rover 802 may comprise a logic module 826, which may place the components of the rover 802 into electrical and logical communication. The electrical and logical communication may allow the components to interact. Accordingly, in some embodiments, the received signals from the components may be processed into different formats and/or interpretations to allow for the logical communication. The logic module 826 may be operable to read and write data and program instructions stored in associated storage 830, such as RAM, ROM, flash, or other suitable memory. In some aspects, the logic module 826 may read a time signal from the clock unit 828. In some embodiments, the rover 802 may comprise an on-board power supply 842. In some embodiments, the rover 802 may be powered from a tethered connection to another device, such as a Universal Serial Bus (USB) connection.

In some implementations, the rover 802 may comprise a network interface 816, which may allow the rover 802 to communicate and/or receive data to a network and/or an associated computing device. The network interface 816 may provide two-way data communication. For example, the network interface 816 may operate according to an internet protocol. As another example, the network interface 816 may comprise a local area network (LAN) card, which may allow a data communication connection to a compatible LAN. As another example, the network interface 816 may comprise a cellular antenna and associated circuitry, which may allow the rover to communicate over standard wireless data communication networks. In some implementations, the network interface 816 may comprise a Universal Serial Bus (USB) to supply power or transmit data. In some embodiments, other wireless links known to those skilled in the art may also be implemented.

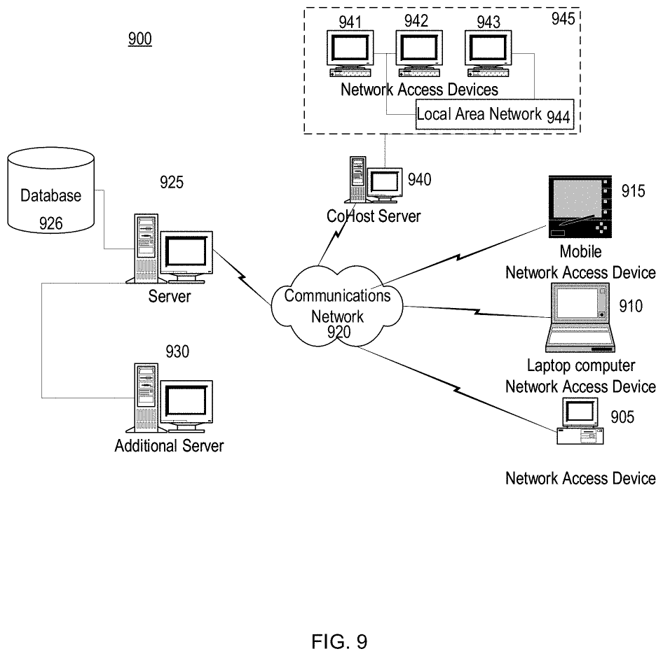

Referring now to FIG. 9, an exemplary processing and interface system 900 is illustrated. In some aspects, access devices 915, 910, 905, such as a paired portable device 915 or laptop computer 910 may be able to communicate with an external server 925 though a communications network 920. The external server 925 may be in logical communication with a database 926, which may comprise data related to identification information and associated profile information. In some embodiments, the server 925 may be in logical communication with an additional server 930, which may comprise supplemental processing capabilities.

In some aspects, the server 925 and access devices 905, 910, 915 may be able to communicate with a cohost server 940 through a communications network 920. The cohost server 940 may be in logical communication with an internal network 945 comprising network access devices 941, 942, 943 and a local area network 944. For example, the cohost server 940 may comprise a payment service, such as PayPal or a social network, such as Facebook or a dating web site.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments, separately, or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multi-tasking and parallel processing may be advantageous. Nevertheless, it will be understood that various modifications may be made without departing from the spirit and scope of the claimed disclosure.

What is claimed is:

1. A rover for performing repetitive processes comprising:
at least one repetitive process mechanism, wherein the rover is configured to perform a first repetitive process, wherein the first repetitive process comprises dispensing a material according to instructions for the first repetitive process;
a supply reservoir configured to contain the material;
a mobility mechanism configured to move the rover, wherein the mobility mechanism is based at least in part on the first repetitive process;
a control mechanism configured to automate performance of the first repetitive process based on instructions through control of one or more of the at least one repetitive process mechanism, the mobility mechanism, and the supply reservoir; and
one or more memory resources configured to store instructions.

2. The rover of claim 1, further comprising:
one or more communication mechanisms configured to communicate with an external device, wherein the control mechanism receives at least a portion of instructions through at least a portion of the one or more communication mechanisms.

3. The rover of claim 2, wherein the rover communicates with an aerial drone configured to provide guidance for the first repetitive process based on visual data.

4. The rover of claim 2, wherein the rover communicates with an external device, wherein the external device provides a reference for position data.

5. The rover of claim 1, wherein the repetitive process comprises painting.

6. The rover of claim 1, wherein the repetitive process comprises treating a body of water.

7. The rover of claim 1, wherein the mobility mechanism provides drone mobility on solid surface.

8. The rover of claim 1, wherein the mobility mechanism provides drone mobility on or under a fluid or semi-solid surface.

9. A system for repetitive processes comprising:
a plurality of rovers, each rover comprising:
at least one repetitive process mechanism, wherein the rover is configured to perform a first repetitive process, wherein the first repetitive process comprises dispensing a material according to instructions for the first repetitive process;
a supply reservoir configured to contain the material;
a mobility mechanism configured to move the rover, wherein the mobility mechanism is based at least in part on the first repetitive process;
a control mechanism configured to automate performance of the first repetitive process based on instructions through control of one or more of the at least one repetitive process mechanism, the mobility mechanism, and the supply reservoir; and
one or more memory resources configured to store instructions, wherein the plurality of rovers are configured to perform the first repetitive process collectively.

10. The system of claim 9, wherein at least a portion of the plurality of rovers further comprises:
one or more communication mechanisms configured to communicate with an external device, wherein the control mechanism receives at least a portion of instructions through at least a portion of the one or more communication mechanisms.

11. The system of claim 10, wherein at least a portion of the plurality of rovers communicates with an external device, wherein the external device provides a reference for position data.

12. The system of claim 10, wherein at least one of the plurality of rovers provides a reference for position data for at least a portion of the plurality of rovers.

13. The system of claim 9, wherein the rover communicates with an aerial drone configured to provide guidance for the first repetitive process based on visual data.

14. The system of claim 9, wherein the repetitive process comprises painting.

15. The system of claim 9, wherein the mobility mechanism provides drone mobility on solid surface.

16. The system of claim 9, wherein the mobility mechanism provides drone mobility on or under a fluid or semi-solid surface.

17. The system of claim 9, wherein at least a portion of the plurality of rovers further comprises a proximity sensor configured to monitor proximity of other rovers within the system.

18. The system of claim 9, further comprising an aerial drone, wherein the aerial drone wirelessly communicates with at least one of the plurality of rovers, and wherein the aerial drone provides rover guidance based on visual data.

19. The system of claim 9, wherein the repetitive process comprises treating a body of water.

20. The system of claim 19, wherein the at least one repetitive process mechanism disperses chemicals into the body of water.
